(19) United States
(12) Patent Application Publication
(10) Pub. No.: US 2004/0101078 A1
(43) Pub. Date: May 27, 2004

(54) Synchronization control method for electronic device

(75) Inventors: Keiichiro Hirata, Fujisawa-shi (JP); Akira Kojima, Fujisawa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Global Storage Technologies Japan, Ltd., Odawara-shi (JP)

(21) Appl. No.: 10/656,902

(22) Filed: Sep. 5, 2003

(30) Foreign Application Priority Data
Sep. 24, 2002 (JP) 2002-276552

(51) Int. Cl. H04L 7/00

(52) U.S. Cl. 375/354

(57) ABSTRACT

An electronic device on a serial interface extracts a timing clock included in data transmitted to another electronic device, constantly monitors the synchronous state of its own timing clock with respect to the extracted timing clock, and if they are out of synchronization with each other, restores the self-synchronization so as to prevent occurrence of data transmission errors due to transmission of data in an asynchronous state. The electronic device operates even when the electronic device is in an idle state receiving no data, to constantly check the synchronous state of a timing clock generated by the electronic device itself with respect to the timing clock of data flowing on the serial interface cable and carry out a self-synchronization operation.

### CROSS-REFERENCES TO RELATED APPLICATIONS

This application claims priority to Japanese Patent Application No. 2002-276552, filed Sep. 24, 2002, the entire disclosure of which is incorporated by reference.

### BACKGROUND OF THE INVENTION

The present invention relates to an information transmission technique between a plurality of electronic devices connected to an interface, and more particularly to a technique which allows an electronic device to, by use of information directed to another electronic device, set a proper timing at which it will receive transmitted information before actually receiving it.

It has become common for a plurality of electronic devices to exchange information using digital signals. In data transmission/reception using digital signals, when data is transmitted through a signal line, each bit representing the digital information (the data) assumes one of two states (0 and 1) to which two levels (high and low) or two widths (long and short) of the voltage applied to the signal line are assigned. To properly receive the data, it is necessary to extract timing information, that is, clock components, from the digital information signals.

To “establish synchronization with a timing clock” is another way of saying to “extract clock components from digital information”. Generally, electronic devices perform the following synchronization control.

With a serial interface, for example, the electronic device on the data transmitting side embeds clock components into the data signal for synchronization control of the data transmission before transmitting the data signal. The electronic device on the receiving side extracts the timing clock from the received data signal and sets the timing clock generated by the electronic device on the receiving side itself such that it synchronizes with the extracted timing signal (this operation is referred to as self-synchronization).

Consider that two levels (high and low) or two widths (long and short) of a voltage are simply assigned to the two states (0 and 1) of each bit. In such a case, if the data signal includes more than a certain number of consecutive 0 bits or 1 bits, the receiving side cannot establish synchronization since the data signal exhibits no change (in the corresponding period). A number of encoding schemes have been developed to prevent this from happening. A representative technique for embedding timing clock components into a data signal for self-synchronization is 8 B/10 B, which is an encoding system in which data is expressed by use of 10-bit code made up of an 8-bit code and two redundant bits.

As a result of the addition of the two redundancy bits to the data, 8 B/10 B-encoded signals exhibit a certain periodical change in the redundancy portions even when the original bit pattern includes a series of 0 bits or 1 bits. This encoding system is adopted by fiber channel, IEEE 1394b, serial ATA, and other serial interfaces.

Conventionally, in this self-synchronization, detection of an asynchronous event and synchronization control are carried out while the data signal is being received.

If the data signal has gone out of synchronization (with the receiving electronic device) for some reason when the receiving electronic device is receiving the data signal, the device will detect a data transmission error and send a notification of the occurrence of the error to the data transmitting electronic device. Receiving the notification, the transmitting electronic device retransmits the data.

Likewise, if data directed to the receiving electronic device is already out of synchronization (with the device), the receiving electronic device will also detect a data transmission error and request the transmitting electronic device to retransmit the data.

Thus, conventionally, an electronic device which has received data out of synchronization (with the device) requests the transmitting electronic device to retransmit the data. In response, the transmitting electronic device retransmits the data, which is a factor in reduction of the data transmission efficiency.

In prior art techniques, only after the receiving electronic device has recognized data addressed to it, does the device begin to extract the clock components embedded in the data and perform the subsequent processing. With this arrangement, however, if the data addressed to the receiving electronic device is out of synchronization (with the device), the receiving electronic device and the transmitting electronic device must repeat transmission of a data retransmission request, retransmission and reception of the data, extraction of a clock, etc., considerably reducing the data transmission efficiency between the transmitting side and the receiving side.

The timing of data transmission goes out of synchronization due to hot plug noise from other electronic devices connected to the interface and external electromagnetic noise. These noises (the causes of the asynchronism) may also be produced while the data is not being received. However, conventional electronic devices can recognize an asynchronous event and restore the self-synchronization only while they are receiving the data.

Representative prior art includes: Japanese Laid-Open Patent No. 62-117052; Japanese Laid-Open Patent No. 5-206847; and Japanese Laid-Open Patent No. 6-232846.

### SUMMARY OF THE INVENTION

According to an aspect of the invention, an electronic device connected to an interface operates, when the electronic device is not receiving data, to monitor information flowing on the interface, extract a clock, referred to as the extracted clock, from the information, and check whether the extracted clock and a clock generated by the electronic device itself, referred to as the self-generated clock, are in synchronization with each other.

The electronic device connected to the interface may also operate, when the electronic device is not receiving data, to set the self-generated clock such that it synchronizes with the extracted clock if the electronic device has detected that they are out of synchronization with each other.

For example, in an arrangement in which a plurality of electronic devices are connected to a fiber channel (FC-AL) through some type of interface, even when an electronic device is not receiving data directed to itself, it can monitor data directed to another electronic device which is flowing on the loop (this data is idle data as viewed from the monitoring electronic device) or it can monitor transmission information on another system sharing the loop to extract clock components from the transmitted information and check the synchronous state of the self-generated clock with respect to the extracted clock.

Furthermore, when the monitoring electronic device has detected an asynchronous event, the electronic device can use clock components included in the idle data or the transmission information on another system to restore self-synchronization. This arrangement allows the electronic device to reliably receive data directed to itself in synchronization with the data transmission clock.

According to an aspect, the invention recognizes that even when a receiving electronic device is not actually receiving the data, the device can establish self-synchronization of its clock beforehand by utilizing other information coming through the interface, such as information addressed to another device. This arrangement allows the receiving electronic device to receive data without errors due to asynchronous events when data addressed to the device is subsequently transmitted.

According to an aspect of the present invention, before receiving data directed to itself, an electronic device establishes synchronization of its clock such that it can receive the data in a synchronous manner, making it possible to prevent occurrence of errors.

According to an aspect of the invention, when a plurality of devices are connected to a serial interface, each receiving device monitors the timing clock of data directed to another device which is flowing through the interface, and sets its own timing clock such that it synchronizes with the timing clock of the data. This arrangement allows the receiving device to receive data directed to itself in a synchronous manner, making it possible to prevent occurrence of data reception errors due to reception of data in an asynchronous state.

A further understanding of the nature and advantages of the present invention may be realized by reference to the remaining portions of the specification and the drawings.

### BRIEF DESCRIPTION OF THE DRAWINGS

FIG. 1 is a block diagram illustrating a synchronization control technique for an electronic device according to an embodiment of the present invention; and

FIGS. 2A and 2B, taken together, provide a flowchart showing the data transmission synchronization processing performed by the data transmission synchronization control section of a peripheral device.

### DESCRIPTION OF SPECIFIC EMBODIMENTS

An embodiment of the present invention will be described with reference to the accompanying drawings.

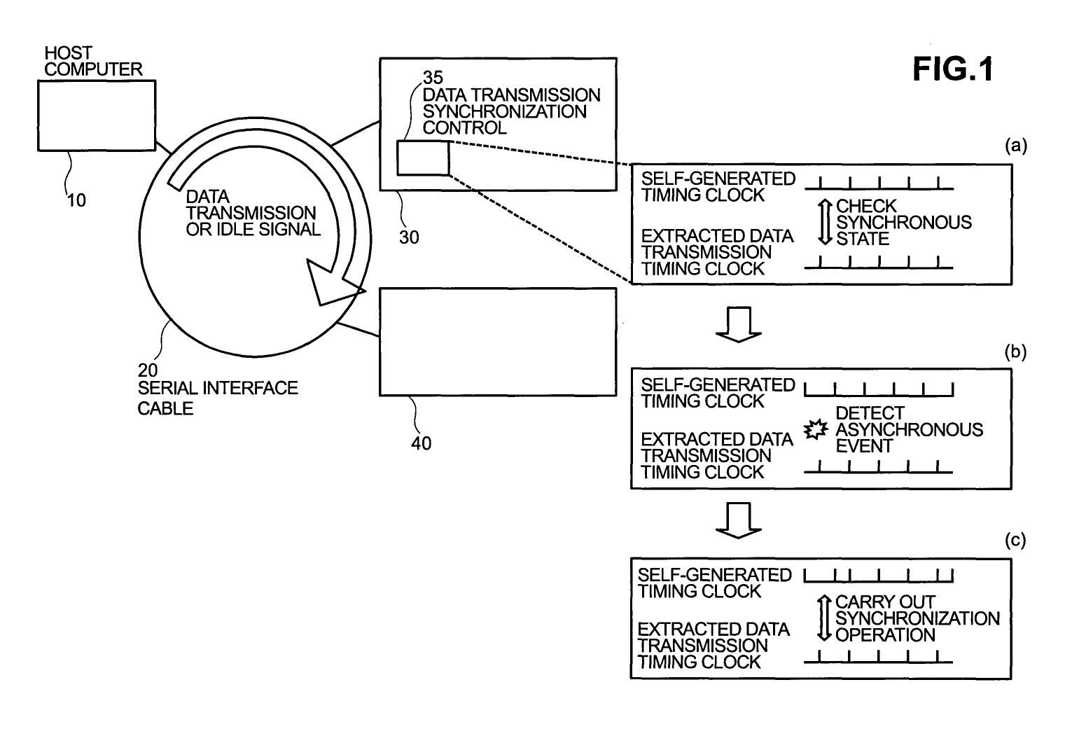

Referring to FIG. 1, a host computer 10 is connected to a serial interface cable 20 installed in a loop such that the host computer 10 can access peripheral devices 30 and 40. The following description assumes that the host computer 10 transmits data to the peripheral device 40.

At that time, a data transmission synchronization control section 35 incorporated in the peripheral device 30 extracts the timing clock embedded in the data directed to the other peripheral device 40 which is flowing on the serial interface cable 20 and compares it with the timing clock generated by the data transmission synchronization control section 35 itself, as indicated by diagram (a). That is, the data transmission synchronization control section 35 checks whether the extracted data transmission timing clock and its self-generated timing clock are in synchronization with each other.

If the data transmission synchronization control section 35 has detected that the extracted data transmission timing clock and the self-generated timing clock are out of synchronization with each other (as in diagram (b)), the data transmission synchronization control section 35 controls its self-generated timing clock such that it synchronizes with the extracted data transmission timing clock (as in diagram (c)).

It should be noted that in this detection of an asynchronous state of a clock, noise randomly generated on the serial interface cable 20 must be excluded. Specifically, the data transmission synchronization control section 35 monitors how long each asynchronous event lasts, and if the section 35 has detected an asynchronous event which has lasted a predetermined period of time or longer, or obtained decisive evidence of asynchronism, the data transmission synchronization control section 35 begins to perform self-synchronization operation.

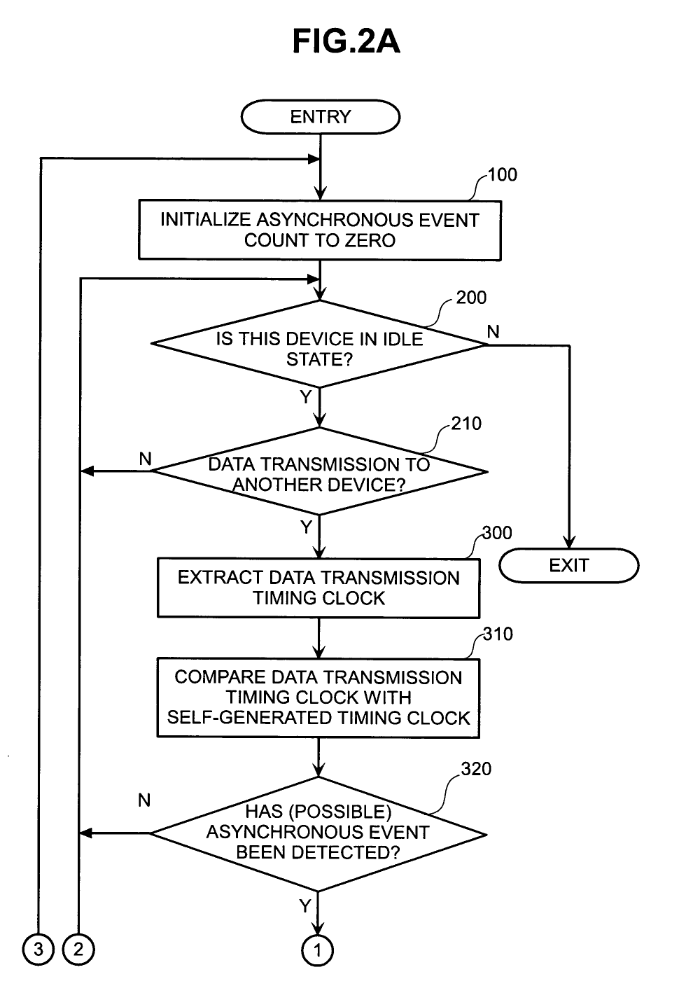

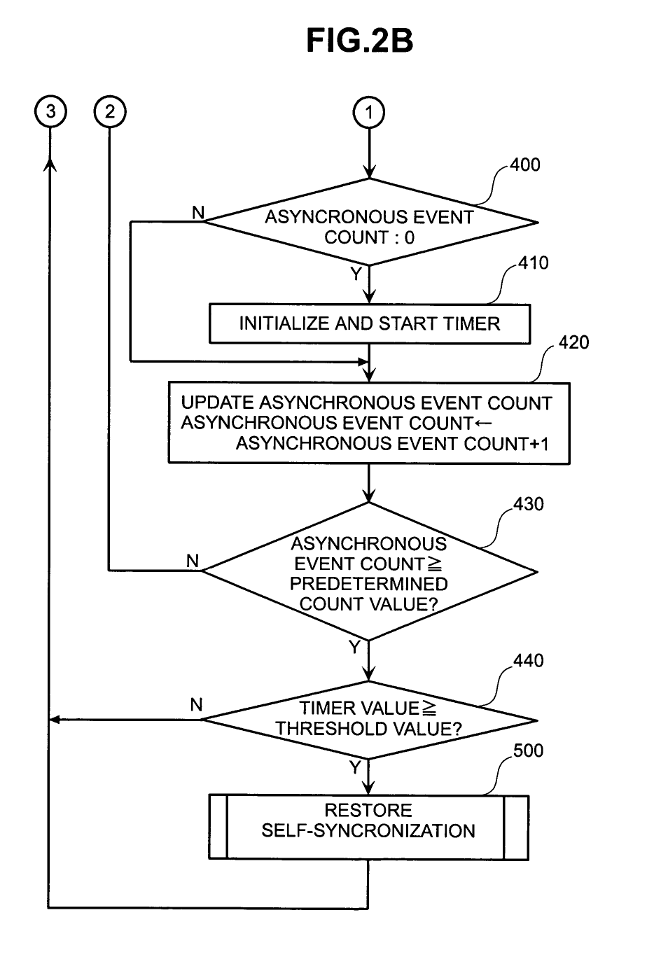

FIGS. 2A and 2B, taken together, show a flowchart of self-synchronization control performed by the data transmission synchronization control section 35.

The data transmission synchronization control section 35 detects an asynchronous event in such a way that randomly generated cable noise is excluded, as described above. To accomplish this, the data transmission synchronization control section 35 includes: an asynchronous event counter for counting the number of asynchronous events which have sequentially occurred for a given period of time; and a timer for measuring the elapsed time.

The asynchronous event count is initialized to zero at step 100. The peripheral device 30 (hereinafter referred to as the receiving device) checks whether its current state is the idle state in which no data (directed to the device) is being transmitted at step 200. If it is not the idle state, the processing ends at EXIT (the receiving device 30 exits this processing).

The receiving device 30 checks whether data, an idle signal, etc. directed to the peripheral device 40 (hereinafter referred to as another device) is flowing on the serial interface cable 20 at step 210. If data directed to another device 40 is flowing on the serial interface cable 20, the receiving device 30 extracts a timing clock from the data at step 300.

The receiving device 30 compares the extracted data transmission timing clock with the timing clock generated by the receiving device 30 itself at step 310. If the receiving device 30 has detected a (possible) asynchronous event at step 320, the receiving device 30 initializes and starts the count register and the timer to check whether the asynchronous state lasts for a predetermined period of time at steps 400 and 410 shown in FIG. 2B.

If the asynchronous state has lasted for the predetermined period of time, the receiving device 30 determines that it has actually detected an asynchronous event and updates the asynchronous event counter by incrementing it at step 420.

If it is determined at steps 430 and 440 that the number of detected asynchronous events is equal to or more than a predetermined count value and the asynchronous state has lasted for a predetermined period of time, the receiving device 30 begins to perform self-synchronization restoration processing at step 500.

Thus, the receiving device establishes its timing beforehand, and if the receiving device has received data directed to itself, it immediately exits the above processing at step 200 to start data reception processing such as data extraction processing, making it possible to considerably reduce the number of asynchronous events taking place.

While the above is a complete description of specific embodiments of the invention, the above description should not be taken as limiting the scope of the invention as defined by the claims.

What is claimed is:

1. A synchronization control method for an electronic device connectable to a serial interface, said synchronization control method comprising:
said electronic device extracting a clock component from information flowing on said serial interface even when said electronic device is not receiving data; and
said electronic device monitoring a synchronous state of a data reception timing clock generated by said electronic device itself with respect to said extracted clock component (clock).

2. The synchronization control method as claimed in claim 1, further comprising:
when said electronic device has detected that a clock made up of said clock component extracted from said information flowing on said serial interface is out of synchronization with said data reception timing clock generated by said electronic device itself, said electronic device performing self-synchronization operation such that said timing clock generated by said electronic device itself synchronizes with said clock made up of said extracted clock component.

3. An electronic device comprising:
a serial interface;
circuitry configured to generate a timing clock; and
synchronization control circuitry configured to
extract a clock component from information present on said serial interface, even when said information is not addressed to said electronic device, and
monitor a synchronous state of said timing clock generated by said electronic device itself with respect to said extracted clock component.

4. The electronic device of claim 1 wherein said synchronization control circuitry is further configured to synchronize said timing clock with said extracted clock component in response to determining that said timing clock is out of synchronization with said extracted clock component.
